(19) United States
(12) Patent Application Publication
(10) Pub. No.: US 2016/0023303 A1
(43) Pub. Date: Jan. 28, 2016

(54) METHOD FOR FORMING THREE-DIMENSIONAL ANCHORING STRUCTURES

(71) Applicant: Siemens Energy, Inc., Orlando, FL (US)

(72) Inventors: Gerald J. Bruck, Oviedo, FL (US); Ahmed Kamel, Orlando, FL (US); Anand A. Kulkarni, Charlotte, NC (US)

(21) Appl. No.: 14/337,623

(22) Filed: Jul. 22, 2014

(51) Int. Cl. B23K 26/00

(52) U.S. Cl. CPC B23K 26/0078; B23K 26/0081; B23K 26/0084

(57) ABSTRACT

A method for texturing a surface to form anchoring structures for a coating. The method includes: traversing an energy beam (10) along a path (30) on a solid substrate surface (12) to cause a melt pool (16) to move along the path; controlling power and motion parameters of the energy beam effective to establish a wave front (18) in the melt pool; and terminating the energy beam at an end (34) of the path when the wave front contains sufficient energy to create a protrusion (22) of material above the surface at the end of the path as the melt pool solidifies.

### FIELD OF THE INVENTION

Aspects of the present invention relate to thermal barrier coating systems for components exposed to high temperatures, such as encountered in the environment of a combustion turbine engine. More particularly, aspects of the present invention are directed to techniques that control laser irradiation to form directionally-aligned, three-dimensional structures that are effective to improve adherence of a layer applied to the textured surface.

### BACKGROUND OF THE INVENTION

It is known that the efficiency of a combustion turbine engine improves as the firing temperature of the combustion gas is increased. As the firing temperatures increase, the high temperature durability of components of the turbine must increase correspondingly. Although nickel and cobalt based superalloy materials may be used for components in the hot gas flow path, such as combustor transition pieces and turbine rotating and stationary blades, even these superalloy materials are not capable of surviving long term operation at temperatures that sometimes can exceed 1,600 degrees C. or more.

In many applications, a metal substrate is coated with a ceramic insulating material, such as a thermal barrier coating (TBC), to reduce the service temperature of the underlying metal and to reduce the magnitude of temperature transients to which the metal is exposed. TBCs have played a substantial role in realizing improvements in turbine efficiency. However, one basic physical reality that cannot be overlooked is that the thermal barrier coating will only protect the substrate so long as the coating remains substantially intact on the surface of a given component through the life of that component.

High stresses that may develop due to high velocity ballistic impacts by foreign objects and/or differential thermal expansion can lead to damage and even total removal of the TBC (spallation) from the component. It is known to control a roughness parameter of a surface in order to improve the adhesion of an overlying thermal barrier coating. U.S. Pat. No. 5,419,971 describes a laser ablation process where removal of material by direct vaporization (e.g., without melting of material) is purportedly used to form three-dimensional structures at the surface being irradiated. U.S. Pat. No. 8,536,483 describes ablation of coatings with high power pulsed laser beams directed by scanning optics, and mentions that some configurations may remove coating to achieve a desired surface roughness. These methods are generally limited to removing material to create the desired texturing, (e.g., do not generally form structures extending outside the surface), and thus processes that can provide improved structural formations conducive to enhanced adhesion are needed.

### BRIEF DESCRIPTION OF THE DRAWINGS

The invention is explained in the following description in view of the drawings that show:

FIG. 1 is a sectional view of a surface of a substrate being irradiated with an energy beam that is controlled to form directionally aligned, three-dimensional protrusions in the surface.

FIG. 2 is a top view of the surface of the substrate of FIG. 1.

### DETAILED DESCRIPTION OF THE INVENTION

In accordance with one or more embodiments of the present invention, structural arrangements and/or techniques conducive to formation of three-dimensional anchoring structures on a surface exposed to controlled energy beam are described herein. In the following detailed description, various specific details are set forth in order to provide a thorough understanding of such embodiments. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components, which would be well-understood by one skilled in the art have not been described in detail to avoid unnecessary and burdensome explanation.

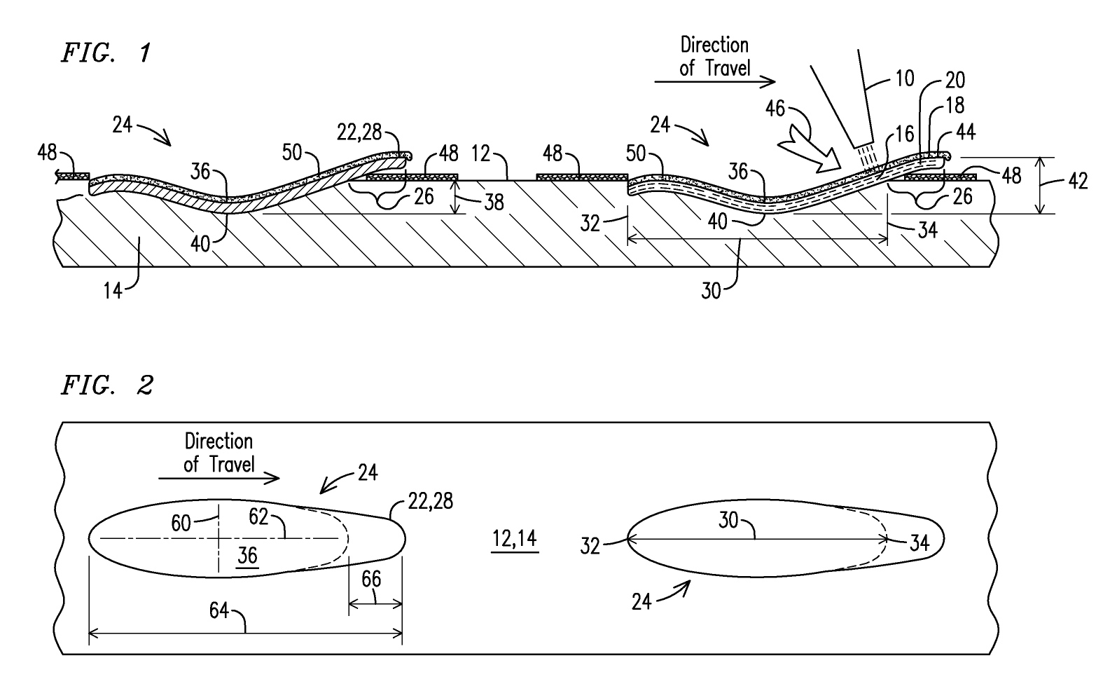

The inventors of the present invention propose innovative utilization of an energy beam to form protrusions on a surface of a substrate. These protrusions act as three-dimensional anchoring structures that enhance adherence of a layer that is subsequently applied to the surface of the substrate. In addition to providing an anchor for a subsequently applied layer, the three dimensional anchoring structures may offer increased thermal conduction (akin to fins in radiators), improved lubricity etc. In one non-limiting embodiment, as shown in FIG. 1, an energy beam 10 moving in a direction of travel may be applied to a surface 12 of a solid substrate 14 to form a melt pool 16 on the surface 12 of the solid substrate 14. For example, as shown in the right-side of FIG. 1, the energy beam 10 may be arranged to melt a relatively shallow layer on the surface 12 of the solid substrate 14. Power and motion parameters of the energy beam 10 are controlled in a manner that may cause the melt pool 16 to move. Energy from the energy beam 10 and plasma created at the substrate surface may contribute to the motion, also referred to herein as a scooping effect, of the melt pool 16. The plasma force may be effective to cause directional expulsion of the material. Various energy beam types for use with the method described herein include laser beams such as, for example, ytterbium fiber, diode, neodymium YAG, carbon dioxide and, most especially, such lasers operated in a pulsed mode. Further, the energy beam may be an alternate source like an electron or plasma beam.

In an exemplary embodiment the energy beam 10 may cause a wave front 18 to form in the melt pool 16. However, a visible wave front 18 in the melt pool 16 is not necessary in order to form the desired protrusion, much as a wave in the middle of the ocean may be undetected, yet contain adequate energy to create a large wave when it strikes a shoreline. When a wave front 18 is formed, it may be formed in front of the energy beam 10, behind, and/or adjacent to the energy beam 10. If there exists a wave front 18 behind the energy beam 10 and in front of the energy beam 10, the two wave fronts 18 may unite when the energy beam is terminated to form a single wave front 18. Whether or not an actual wave front 18 per se is formed, the energy and motion of the energy beam 10 are effective to form a liquid protrusion 20 that extends above the surface 12, and the energy and motion are controlled to ensure that the liquid protrusion 20 solidifies while it is above the surface 12 to form a solidified protrusion 22. This is visible in the left side of FIG. 1, which shows a three-dimensional anchoring structure 24 that was formed earlier in time (due to the direction of travel of the energy beam 10 from left to right). The energy beam may be terminated at any time once the melt pool has enough energy to form the liquid protrusion 20. In the exemplary embodiment shown in FIG. 1, where a wave front 18 is formed, an interaction of the wave front 18 and adjacent solid/unmelted (i.e. not melted by the energy beam 10) substrate 26 can be utilized to cause the wave front 18 to curl and extend over the adjacent solid substrate 26. The cantilevered wave front 18 solidifies in this position, thereby forming a cantilevered protrusion, referred to herein as a hook 28 of the three-dimensional anchoring structure 24. This exemplary embodiment is not limiting, however, and the protrusion need not overhang adjacent solid substrate 26.

In an exemplary embodiment, the energy beam 10 may be a pulsed laser beam and the motion may be accomplished using laser scanning optics (e.g. galvanometer driven mirrors) and commensurate optics control software and controller(s). Alternately, the surface 12 may be moved relative to the energy beam 10. The surface to be textured may be a substrate, such as a superalloy used in a gas turbine engine component. Typical superalloys for use in the preferred embodiment of surface modification include, but are not limited to, CM 247, Rene 80, Rene 142, Rene N5, Inconel-718, X750, 617, 738. 792, and 939, PWA 1483 and 1484, C263, ECY 768, CMSX-4, Hast-X and X45. In such case, the protrusions will be formed in the superalloy substrate and may act to improve adherence of a bond coat applied to the superalloy substrate.

Alternately, or in addition, the surface to be textured may be a bond coat (e.g. an MCrAIY material) that has been applied to a superalloy substrate. In this case, the protrusions will be formed in the bond coat and may act to improve adherence of a thermal barrier coating (TBC) applied to the bond coat. However, the preceding examples are not meant to be limiting, and the process may be applied to a variety of surfaces. The component may be a new component or a stripped and repaired component, such as a turbine blade or vane. Alternately, the substrate can be a repaired component where significant bond coat is left on the component to be refurbished. In this instance the bond coat may be textured in anticipation of the application of the TBC.

In an exemplary embodiment where the surface to be textured is a bond coat disposed on a superalloy substrate, approximately 125-300 microns (0.005 inches-0.012 inches) of bond coat may be applied to the superalloy substrate. The energy beam 10 is controlled such that the energy beam 10 is pulsed along a path 30 across the surface 12 using the laser scanning optics, initiating at a beginning 32 of the path 30 and terminating at an end 34 of the path 30. In an exemplary embodiment, energy beam parameters include a speed of the energy beam 10 that may be 0.02 meters/second, a power output that may be 1 kW, a frequency that may be 0.01 kHz, and a duration that may be a 50,000 microsecond pulse. Using these parameters, the energy beam 10 may form a divot 36 of the three-dimensional anchoring structure 24 having a divot depth 38 from a divot bottom 40 to the surface 12 of about 30 microns. The path 30 may be approximately one millimeter long. The three-dimensional anchoring structure 24 may have a structure depth 42 approximately 60 microns from the divot bottom 40 to a top 44 of the hook 28. The result is a process that can quickly and efficiently produce a pattern of the three-dimensional anchoring structures 24 through rapid scanning of the pulsed energy beam. One skilled in the art will appreciate that the energy beam 10 may be controlled (e.g., power and focal point etc.) to achieve desired divot characteristics and desired dimensions of the three-dimensional anchoring structures 24.

In an alternate embodiment, instead of maintaining a constant power, the power of the energy beam 10 may be varied to maximize the formation of the liquid protrusion 20. For example, the power may be spiked immediately before its termination to enhance a propulsive effect of the energy beam 10. Likewise, other parameters may be varied as desired to achieve the desired three-dimensional anchoring structures 24.

Optionally, mechanical assistance may also be used to mechanically drive the formation of the liquid protrusion 20 and the associated solid protrusion 22. For example, an assist gas 46 may be used, such as, for example, laser fiber cooling air that is properly oriented to push the melt pool 16. Alternately, other forms of mechanical assistance can be used, such as a discrete source of assist gas 46, or ultrasonic energy etc. Alternatively, a further application of an energy beam may be used to apply a mechanical push to the protrusion 20 by creating a shock wave in the melt pool 16 via rapid vaporization of material.

Also optionally, a flux 48 may be prepositioned on the surface 12 where the energy beam 10 is to traverse the surface 12. The flux will assist coupling of the laser beam optical energy. The flux 48 will be melted by the energy beam 10 and incorporated as a molten slag 50 over the melt pool 16, where such slag 50 acts to protect the melt pool 16 from atmospheric contaminants. After treatment, the solidified slag 50 resulting from the flux melting may be removed by any of the well-known techniques, such as mechanical brushing, grit blasting etc.

The flux 48 may also be formulated to control a viscosity of the melt pool 16. Reducing the viscosity results in a faster fluid flow velocity, and this promotes formation of the three-dimensional anchoring structures 24. In contrast, increasing the viscosity results in slower fluid flow velocity, and this has the opposite effect. Small additions of silicon are effective to reduce viscosity and promote good metal motion. Therefore, an amount of silicon in the flux 48 may be adjusted to influence the formation of the three-dimensional anchoring structures 24. Embodiments of flux 48 may include at least 0.25 wt. % silicon, or at least 0.50 wt. % silicon, or 0.50-0.75 wt. % silicon.

The formation of the anchoring structures 24 may also be promoted by relatively deeper penetration of the melt pool 16. Such penetration can be affected by flow that can be driven toward or away from the heat source (e.g. the energy beam 10) with more or less downward flow or penetration in the melt pool. Sulfur promotes a positive temperature coefficient of surface tension. As a result of the Marangoni effect, this increases penetration and promotes the formation of the three-dimensional anchoring structures 24. Aluminum has the opposite effect. Therefore, the sulfur and/or aluminum content of the flux 48 may be regulated to influence the formation of the three-dimensional anchoring structures 24. Embodiments of flux 48 may include at least 0.010 wt. % sulfur, or at least 0.020 wt. % sulfur, or 0.010-0.030 wt. % sulfur.

The shape of the bottom of the melt pool 16 and the speed of travel of the melt pool across the surface 12 will also affect the formation of the anchoring structures 24, much as the speed of an ocean wave and the shape of a beach affect the shape of waves upon a shoreline. Accordingly, the energy beam 10 may be controlled in a manner effective to impart a desired shape/size to the anchoring structures 24.

In lieu of using a flux, one may control environmental conditions using a suitable enclosure while performing the foregoing process. For example, depending on the needs of a given application, one may choose to perform the energy beam process under vacuum conditions in lieu of atmospheric pressure, or one may choose to introduce an inert gas in lieu of air.

As can be seen in FIG. 2, the three-dimensional anchoring structures 24 are elongated in the direction of travel. That is, the three-dimensional anchoring structure 24 is oval-shaped with a narrow axis 60 transverse to the direction of travel and of approximate dimension of a diameter of the energy beam 10. A long axis 62 is oriented parallel to the direction of travel. A length 64 of the three-dimensional anchoring structure 24 is characterized by the pulse duration and travel speed of the energy beam 10 plus an overhang length 66 of the hook 28. The hook 28 serves to mechanically interlock with a subsequently applied layer, thereby improving adherence of the applied layer.

The direction of travel of the energy beam 10 may be one-way along a straight traversal, which would form three-dimensional anchoring structures 24 and hooks 28 that are all aligned with the direction of travel. This traversal may be repeated such that several parallel rows of three-dimensional anchoring structures 24 are formed, all with aligned hooks 28. Alternately, additional energy beam traversals may be parallel but with varying directions of travel, or the traversals may be patterned in any arrangement and have a plurality of directions of travel. This would result in a pattern having hooks 28 that point in a plurality of directions, and this would increase bond strength in multiple directions. The various described foregoing processes may be iteratively performed throughout the surface 12 to form a large number of three-dimensional anchoring structures 24 thereon. Moreover, three-dimensional anchoring structures 24 may be selectively distributed throughout surface 12. For example, surface regions expected to encounter a relatively large level of stress may be engineered to include a larger number of three-dimensional anchoring structures 24 per unit area compared with surface regions expected to encounter a relatively lower level of stress.

The energy beam 10 may be angled such that it points into the direction of travel, and this may enhance the scooping effect. Alternately, the direction of travel may be curvilinear, for example an arc. This may form a three-dimensional anchoring structure 24 where the solidified protrusion 22 forms a sweeping overhang or the like.

In the preceding detailed description, various specific details are set forth in order to provide a thorough understanding of the invention and its various embodiments. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components that would be well-understood by one skilled in the art have not been described in detail to avoid unnecessary and burdensome explanation.

Furthermore, various operations have been described as multiple discrete steps performed in a manner that is helpful for understanding embodiments of the present invention. However, the order of description should not be construed to infer that these operations must be performed in the order they are presented, nor that they are even order-dependent unless otherwise so described. Moreover, repeated usage of the phrase “in one embodiment” does not necessarily refer to the same embodiment, although it may. Lastly, the terms “comprising”, “including”, “having”, and the like, as used in the present application, are intended to be synonymous unless otherwise indicated. Accordingly, it is intended that the invention be limited only by the spirit and scope of the appended claims.

The invention claimed is:

1. A method, comprising:
traversing an energy beam along a path on a solid substrate surface to cause a melt pool to move along the path;
controlling power and motion parameters of the energy beam effective to establish a wave front in the melt pool; and
terminating the energy beam at an end of the path when the wave front contains sufficient energy to create a protrusion of material above the surface at the end of the path as the melt pool solidifies.

2. The method of claim 1, further comprising forming the protrusion over adjacent unmelted solid substrate, and solidifying the protrusion over the adjacent unmelted solid substrate.

3. The method of claim 1, further comprising moving the energy beam across the solid substrate surface in only one direction of travel along a straight line, and forming a divot in the solid substrate surface during the traversal that is elongated in the direction of travel of the energy beam.

4. The method of claim 1, further comprising maintaining a constant power output of the energy beam during the traversal.

5. The method of claim 1, further comprising positioning the energy beam so that it points into a direction of travel of the energy beam.

6. The method of claim 1, further comprising providing an additional mechanical push to the melt pool to help form the protrusion.

7. The method of claim 6, wherein the additional mechanical push comprises an assist gas configured to push the melt pool along a direction of travel of the energy beam during the traversal.

8. The method of claim 1, further comprising repeatedly traversing the energy beam to form a pattern of protrusions.

9. The method of claim 1, wherein the solid substrate surface comprises a bond coat.

10. The method of claim 1, wherein the solid substrate surface comprises a superalloy substrate.

11. The method of claim 1, further comprising incorporating a flux comprising silicon into the melt pool.

12. The method of claim 1, further comprising incorporating a flux comprising sulfur into the melt pool.

13. A method, comprising:
traversing an energy beam along a path on a solid substrate surface;
controlling power and motion parameters of the energy beam effective to cause a melt pool to move along the path;
terminating the energy beam at an end of the path effective to cause the melt pool to interact with adjacent solid substrate material to form a protrusion of material above the surface at the end of the path when the melt pool solidifies.

14. The method of claim 13, further comprising forming the protrusion over adjacent unmelted solid substrate.

15. The method of claim 13, further comprising moving the energy beam across the solid substrate surface in only one direction along a straight line.

16. The method of claim 13, further comprising varying a power output of the energy beam during the traversal to aid formation of the wave front.

17. The method of claim 13, further comprising pushing melted substrate material with an assist gas to aid formation of a wave front in the melt pool.

18. The method of claim 13, further comprising positioning the energy beam so that it points into a direction of travel of the energy beam.

19. The method of claim 13, wherein the solid substrate surface is defined by a bond coat.

20. The method of claim 13, further comprising incorporating a flux comprising at least one of silicon and sulfur into the melt pool.
